(19) United States
(12) Patent Application Publication
(10) Pub. No.: US 2026/0106298 A1
(43) Pub. Date: Apr. 16, 2026

(54) BATTERY MODULE AND METHOD FOR MANUFACTURING BATTERY MODULE

(71) Applicants: Hyundai Motor Company, Seoul (KR); Kia Corporation, Seoul (KR)

(72) Inventors: Ju Hee KIM, Hwaseong-si (KR); Jun Young KANG, Hwaseong-si (KR); Ji Woong JUNG, Hwaseong-si (KR); Hyun Chang KANG, Hwaseong-Si (KR)

(73) Assignees: Hyundai Motor Company, Seoul (KR); Kia Corporation, Seoul (KR)

(21) Appl. No.: 19/242,795

(22) Filed: Jun. 18, 2025

(30) Foreign Application Priority Data
Oct. 11, 2024 (KR) 10-2024-0138949

(51) Int. Cl. H01M 50/26; H01M 10/48; H01M 10/613; H01M 10/6555; H01M 10/6567; H01M 50/271; H01M 50/505

(52) U.S. Cl. CPC H01M 50/26; H01M 10/486; H01M 10/613; H01M 10/6555; H01M 10/6567; H01M 50/271; H01M 50/505

(57) ABSTRACT

Disclosed is a battery module including battery cells extending in a first direction, and disposed in a second direction crossing the first direction, a sensing assembly disposed on one side of the battery cell in the first direction, a module housing that covers the battery cells and the sensing assembly, a cover coupled to the module housing and covering the sensing assembly, and a sealing gasket disposed between the cover and the sensing assembly and that fixes the sensing assembly.

### CROSS-REFERENCE TO RELATED APPLICATION

The present application claims the benefit of priority to Korean Patent Application No. 10-2024-0138949, filed in the Korean Intellectual Property Office on Oct. 11, 2024, the entire contents of which are incorporated herein by reference.

### TECHNICAL FIELD

The present disclosure relates to a battery module, and a method for manufacturing the battery module.

### BACKGROUND

Recently, as awareness of the crisis of the environment and depletion of petroleum resources has increased, research and development on electric vehicles, which are eco-friendly vehicles, has been highlighted. Electric vehicles include plug-in hybrid electric vehicles (PHEVs), battery electric vehicle (BEVs), and fuel cell electric vehicles (FCEVs).

Electric vehicles use battery cells as a power source, and because temperature increases due to heat generation when battery cells are used are inevitable, it is essential to construct a battery module to maintain the temperature of the battery cells in an appropriate range to prevent a thermal runaway.

There are various methods for maintaining the temperature of the battery cells in an appropriate range, such as air cooling, which uses air to cool the battery cells, indirect liquid cooling, which uses cooling plates to cool the battery cells, and immersion cooling.

Among these, as the battery capacity and load of electric vehicles increase, research on the immersion cooling method with a high cooling performance is increasing. Meanwhile, a need for a battery module that secures the sealing performance of cooling liquid that flows through an interior of the battery module according to the immersion cooling method is increasing.

### SUMMARY

The present disclosure has been made to solve the above-mentioned problems occurring in the related art while advantages achieved by the related art are maintained intact.

An aspect of the present disclosure provides a battery module that secures a sealing performance of cooling liquid that flows through an interior of the battery module.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery module includes battery cells extending in a first direction, and disposed in a second direction crossing the first direction, a sensing assembly disposed on one side of the battery cell in the first direction, a module housing that covers the battery cells and the sensing assembly, a cover coupled to the module housing and covering the sensing assembly, and a sealing gasket disposed between the cover and the sensing assembly and that fixes the sensing assembly.

The sealing gasket may extend along a circumferential direction of the cover.

The sealing gasket may contact both of a circumferential area of the cover and a circumferential area of the sensing assembly, between the cover and the sensing assembly.

The sealing gasket may include a peripheral portion contacting with the cover and extending along a circumferential direction of the cover, and an extension portion extending from the peripheral portion toward the sensing assembly and contacting with the sensing assembly.

The sensing assembly may include a sensing board, and a support frame supporting the sensing board, and the extension portion may contact with the support frame.

The support frame may include a support portion supporting the sensing board, and a protrusion portion protruding from a circumferential area of the support portion toward the cover, and extending along the circumferential direction of the support portion, and the extension portion may contact with the protrusion portion, inside of the protrusion portion.

The peripheral portion may be disposed between the cover and the module housing, and contacts with the cover and the module housing.

The peripheral portion and the extension portion of the sealing gasket may define an opening hole in an interior of the sealing gasket.

The sealing gasket may extend in a circumferential direction of the cover and defines an opening hole in an interior of the sealing gasket.

The sensing assembly may include a busbar electrically connected to the battery cells, and the opening hole may be formed on one side of the busbar in the first direction thereof.

The cover may include a cover hole fluidically communicating with the opening hole.

The cover hole may include a first cover hole disposed on one side of the battery cell stack in the first direction and a second cover hole disposed on an opposite side of the battery cell stack in the first direction.

The battery module may further include cooling plates disposed in the module housing and surface-pressure members disposed between the battery cells and contacting with the battery cells.

According to another aspect of the present disclosure, a method for manufacturing a battery module includes stacking battery cells extending in a first direction, in a second direction crossing the first direction, assembling a sensing assembly on one side of the battery cells in the first direction, mounting the battery cells and the sensing assembly in a module housing, assembling a sealing gasket on one side of the sensing assembly in the first direction, and a cover coupling operation coupling a cover for covering the sealing gasket to the module housing.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a battery module according to an exemplary embodiment of the present disclosure;

FIG. 2 is an exploded perspective view of a battery module according to an exemplary embodiment of the present disclosure;

FIG. 3 is a longitudinal cross-sectional view of a battery module, taken along line A-A′ illustrated in FIG. 1;

FIG. 4 is a longitudinal cross-sectional view of a battery module, taken along line B-B′ illustrated in FIG. 1;

FIG. 5 is an enlarged view of a battery module illustrated in FIG. 4;

FIG. 6 is a side view of a sealing gasket according to an exemplary embodiment of the present disclosure;

FIG. 7 is a view exemplarily illustrating a flow direction of a cooling liquid that flows in an interior of a battery module according to an exemplary embodiment of the present disclosure;

FIG. 8 is an enlarged view of one side portion of a battery module in a first direction according to an exemplary embodiment of the present disclosure;

FIG. 9 is an enlarged view of an opposite side portion of a battery module in a first direction according to an exemplary embodiment of the present disclosure;

FIG. 10 is an enlarged view exemplarily illustrating a flow direction of a cooling liquid which is introduced into an interior of a battery module and flows to battery cells according to an exemplary embodiment of the present disclosure; and

FIG. 11 is a method of manufacturing a battery module according to an exemplary embodiment of the present disclosure.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the exemplary embodiments of the present disclosure, when it is determined that a detailed description of related known configurations and functions may hinder understanding of the exemplary embodiments of the present disclosure, a detailed description thereof will be omitted.

Furthermore, in describing the components of the exemplary embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

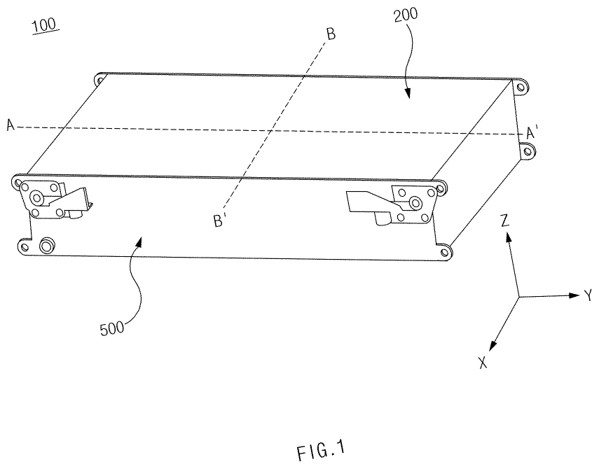

Hereinafter, embodiments of the present disclosure will be described in detail with reference to FIGS. 1 to 11.

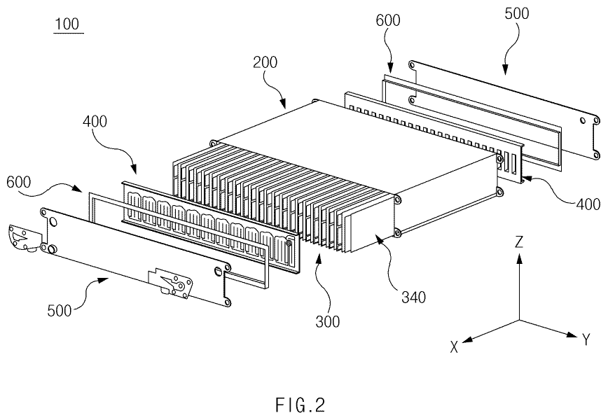

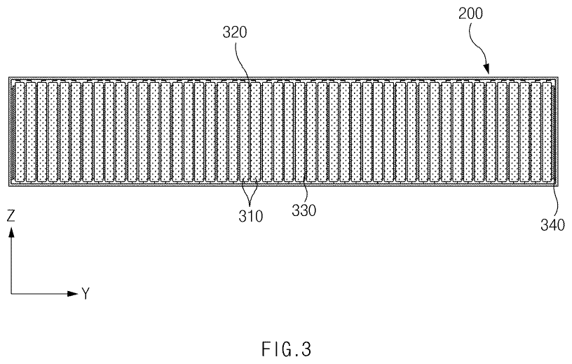

FIG. 1 is a perspective view of a battery module according to an exemplary embodiment of the present disclosure. FIG. 2 is an exploded perspective view of a battery module according to an exemplary embodiment of the present disclosure. FIG. 3 is a longitudinal cross-sectional view of a battery module, taken along line A-A′ illustrated in FIG. 1.

Referring to FIGS. 1 to 3, a battery module 100 may include a module housing 200 and a battery cell stack 300 which is accommodated in an interior of the module housing 200.

The module housing 200 may be formed such that opposite side areas in a first direction (i.e., the “X” direction and an opposite direction to the “X” direction) are opened. The battery cell stack 300 may be inserted into an interior of the module housing 200 through one side area (i.e., the “X” direction) in the first direction or an opposite side area (i.e., an opposite direction to the “X”direction) in the first direction thereof.

The battery cell stack 300 may include battery cells 310 that extend in the first direction and are disposed in a second direction (the “Y” direction or an opposite direction to the “Y” direction) which is perpendicular to the first direction thereof. The battery cell stack 300 may include cooling plates 320 and surface-pressure members 330 that are disposed between the battery cells 310 and are alternately disposed. The cooling plates 320 or the surface-pressure members 330 may be alternately disposed between the battery cells 310 that are adjacent to each other in the second direction thereof.

The cooling plate 320 may contact with the battery cells 310 to prevent an increase in the temperature of the battery cells 310. The surface-pressure member 330 may contact with the battery cells 310 to prevent a swelling phenomenon of the battery cells 310.

End plates 340 may be disposed on opposite sides of the battery cell stack 300 in the second direction, and each of the pair of end plates 340 may press the battery cell stack 300 between the module housing 200 and the battery cell stack 300.

The battery module 100 may include a pair of sensing assemblies 400 that are disposed on opposite sides of the battery cell stack 300 in the first direction, and a pair of covers 500 that cover external sides of the pair of sensing assemblies 400 in the first direction, respectively.

The sensing assembly 400 may include a sensing board that senses a pressure or temperature of the battery cells 310, and a busbar that is electrically connected to the battery cells 310.

The module housing 200 may cover opposite areas of the battery cell stack 300 and the sensing assembly 400 in the first direction, and opposite areas thereof in the third direction (the “Z” direction and a direction opposite to the “Z” direction). Here, the third direction (the “Z” direction or an opposite direction to the “Z” direction) may be a direction which is perpendicular to the first direction and the second direction thereof.

The pair of covers 500 may be coupled to the module housing 200 to cover opposite side areas of the module housing 200 in the first direction thereof. The pair of covers 500 may cover the pair of sensing assemblies 400, respectively.

Meanwhile, the battery module 100 according to an exemplary embodiment of the present disclosure may be a battery module for a method of cooling the battery cells 310 according to an immersion cooling method.

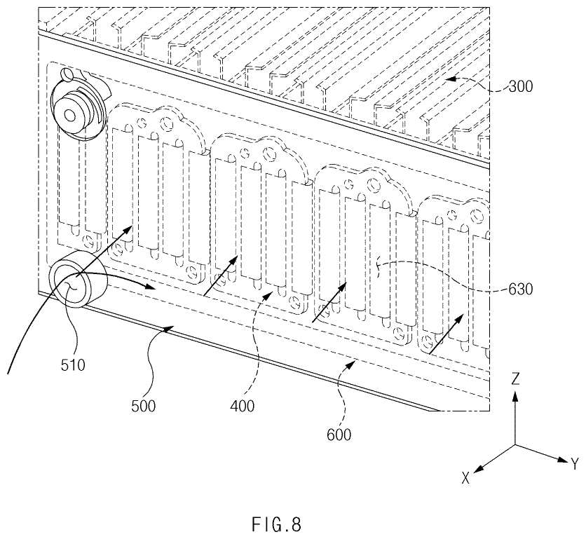

The immersion cooling may be a cooling method, in which a cooling liquid flows into the interior of the battery module 100 to prevent a temperature of the battery cell 310 from rising. To the present end, a cover hole 510 (see FIG. 8) for introducing or discharging the cooling liquid may be disposed in a cover 500.

The battery module 100 may include a sealing gasket 600 for preventing leakage of the cooling liquid that flows into the interior of the battery module 100. The sealing gasket 600 may be disposed between the cover 500 and the sensing assembly 400. The sealing gasket 600 may extend along a circumferential direction of the cover 500.

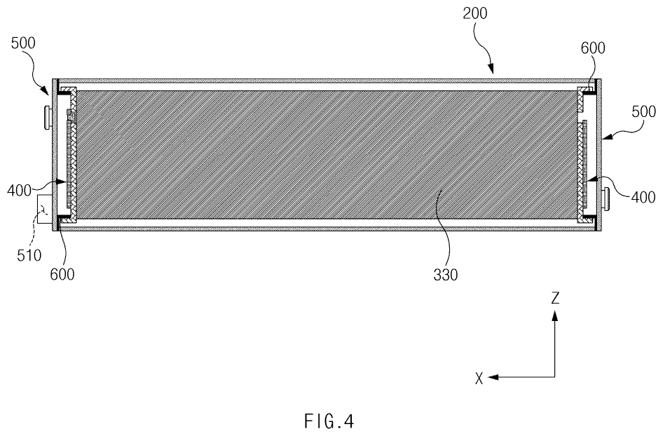

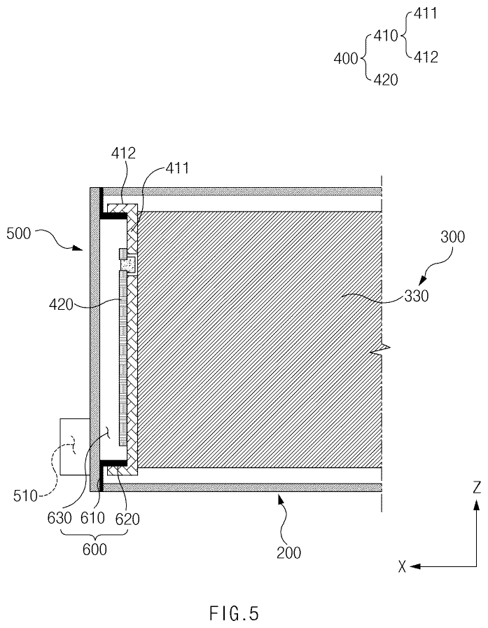

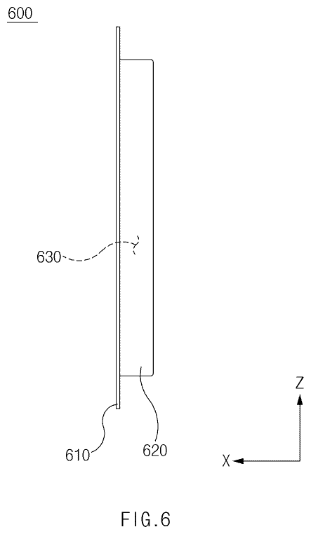

FIG. 4 is a longitudinal cross-sectional view of a battery module, taken along line B-B′ illustrated in FIG. 1. FIG. 5 is an enlarged view taken along a dotted line illustrated in FIG. 4. FIG. 6 is a side view of a sealing gasket according to an exemplary embodiment of the present disclosure.

Referring to FIGS. 4 to 6, a pair of sealing gaskets 600 may be provided and may be disposed between the sensing assembly 400 and the cover 500, respectively.

The sealing gasket 600 may include a peripheral portion 610 that contacts with the cover 500 and extends along a circumferential direction of the cover 500, and an extension portion 620 that extends from the peripheral portion 610 toward the sensing assembly 400 and contacts with the sensing assembly 400. In other words, the peripheral portion 610 may extend from the extension portion 620 in the third direction and the second direction to include a flange shape.

The sealing gasket 600 may extend in the circumferential direction of the cover 500 to form an opening hole 630 in an interior thereof. The opening hole 630 may be a space, through which the cooling liquid introduced into the interior of the battery module 100 (refer to FIG. 1) through the cover 500 flows. The opening hole 630 defined by the peripheral portion 610 and the extension portion 620 may extend in the first direction and pass through opposite areas of the sealing gasket 600 in the first direction thereof. The opening hole 630 may be formed on one side or an opposite side of the busbar in the first direction thereof.

In the present way, the sealing gasket 600 may contact both the circumferential area of the cover 500 and the circumferential area of the sensing assembly 400, between the cover 500 and the sensing assembly 400. The sealing gasket 600 may contact both the circumferential area of the cover 500 and the circumferential area of the sensing assembly 400, preventing the cooling liquid that flows through the opening hole 630 from leaking to the outside of the battery module 100.

Furthermore, the sealing gasket 600 may fix a position of the sensing assembly 400 and separate the cover 500 and the sensing assembly 400 at the same time.

In more detail, the sensing assembly 400 may include a support frame 410 that supports the sensing board, and a busbar coupling frame 420 which is coupled to the support frame 410 to provide a busbar.

The support frame 410 may include a support portion 411, to which a sensing board is attached, and a protrusion portion 412 that protrudes toward the cover 500 from the circumferential area of the support portion 411 and extends along the circumferential direction of the support portion 411.

In the instant case, the peripheral portion 610 of the sealing gasket 600 may be disposed between the cover 500 and the module housing 200 to contact both the cover 500 and the module housing 200, and the extension portion 620 of the sealing gasket 600 may extend toward the sensing assembly 400 from a side of the peripheral portion 610, which is adjacent to the opening hole 630. The extension portion 620 may contact with the protrusion portion 412 of the support frame 410.

The extension portion 620 may contact with the protrusion portion 412, inside the protrusion portion 412. In other words, the protrusion portion 412 may be fixed in position by the extension portion 620 because the protrusion portion 412 is supported by the extension portion 620 on two internal sides, on which the protrusion portions 412 face each other.

According to the structure, because the pair of sensing assemblies 400 may be fixed at opposite sides of the battery cell stack 300 in the first direction, respectively, a structural stability of the battery module 100 may be ensured.

Furthermore, due to the structure, the positions of the sensing assembly 400, the sealing gasket 600, and the cover 500 are guided during a manufacturing process of the battery module 100, so that a productivity of the battery module 100 may be improved.

Furthermore, because the sealing gasket 600 fixes the position of the sensing assembly 400, an insulation breakdown between the busbars of the sensing assembly 400 may be prevented even though an impact or the like is transmitted from the outside thereof.

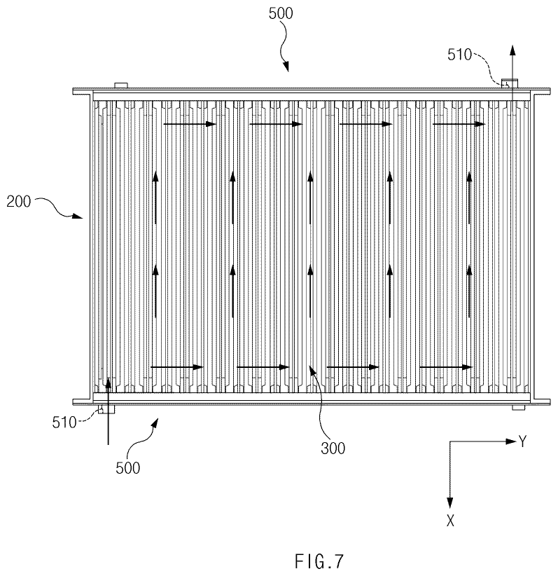

Hereinafter, a flow direction of the cooling liquid will be described in detail with reference to FIGS. 7 to 10.

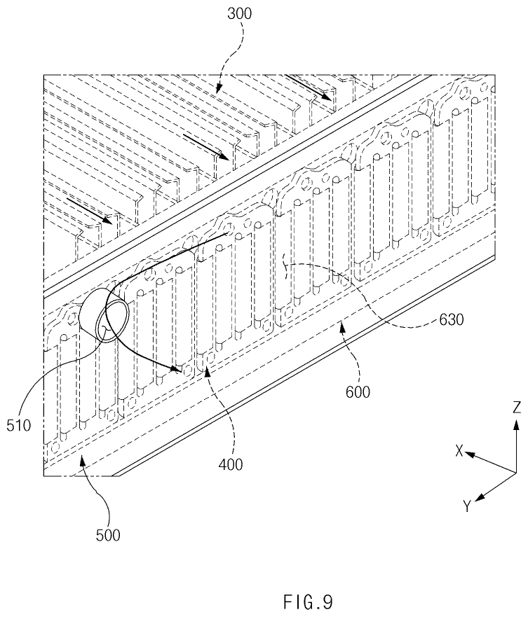

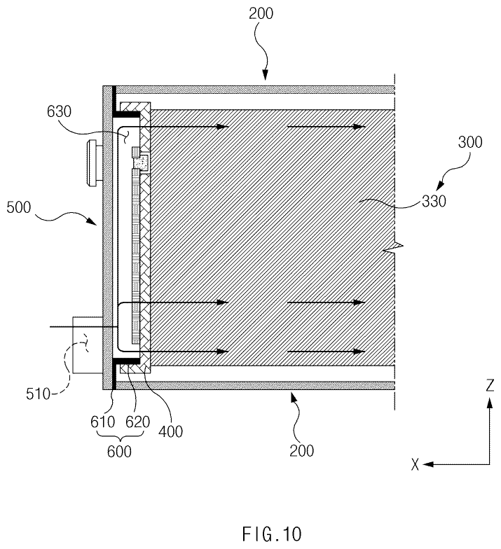

FIG. 7 is a view exemplarily illustrating a flow direction of a cooling liquid that flows in an interior of a battery module according to an exemplary embodiment of the present disclosure. FIG. 8 is an enlarged view of one side portion of a battery module in a first direction according to an exemplary embodiment of the present disclosure. FIG. 9 is an enlarged view of an opposite side portion of a battery module in a first direction according to an exemplary embodiment of the present disclosure. FIG. 10 is an enlarged view exemplarily illustrating a flow direction of a cooling liquid which is introduced into an interior of a battery module and flows to battery cells according to an exemplary embodiment of the present disclosure.

Referring to FIGS. 7 to 10, a cover hole 510 may be disposed in the cover 500. The cover hole 510 may fluidically communicate with the opening hole 630. The cover hole 510 of the cover 500 disposed on one side of the battery cell stack 300 in the first direction and the cover hole 510 of the cover 500 disposed on an opposite side of the battery cell stack 300 in the first direction may be spaced apart from each other in the second direction and the third direction thereof.

That is, the cover hole 510 of the cover 500 disposed on the one side of the battery cell stack 300 in the first direction may be an inlet hole, through which the cooling liquid is introduced into the interior of the battery module 100 (refer to FIG. 1), and the cover hole 510 of the cover 500 disposed on the opposite side of the battery cell stack 300 in the first direction may be an outlet hole, through which the cooling liquid is discharged from the battery module 100.

With the above-described structure, a length of the passage in the interior of the battery module 100 may be maximized through the cover hole 510 of the cover 500 disposed on the one side of the battery cell stack 300 in the first direction and the cover hole 510 of the cover 500 disposed on the opposite side of the battery cell stack 300 in the first direction, and a cooling effect of the battery cells 310 (see FIG. 3) may be improved.

As illustrated in FIG. 10, the cooling liquid introduced into the interior of the battery module 100 through the cover hole 510 of the cover 500 disposed on the one side of the battery cell stack 300 in the first direction may flow in the third direction while flowing through the opening hole 630. In the instant case, the cooling liquid that flows toward opposite sides in the third direction may be guided to the battery cell stack 300 by internal surfaces of the peripheral portion 610, which face each other, and internal surfaces of the extension portion 620, which face each other. With the structure, leakage of the cooling liquid to the outside of the battery module 100 may be prevented, and a cooling performance of the battery cell 310 may be improved.

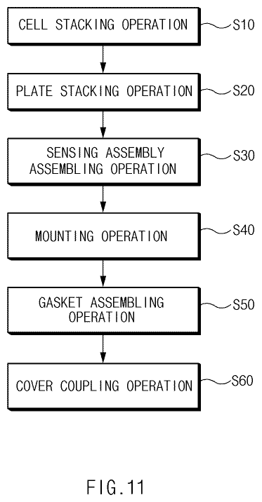

FIG. 11 is a method of manufacturing a battery module according to an exemplary embodiment of the present disclosure.

Referring to FIGS. 2 and 11, the method for manufacturing a battery module may include a cell stacking operation S10, a plate stacking operation S20, a sensing assembly assembling operation S30, a mounting operation S40, a gasket assembling operation S50, and cover coupling operation S60.

The cell stacking operation S10 may be an operation of stacking the battery cells 310 that extend in the first direction, in the second direction thereof.

The cell stacking operation S10 may include stacking the cooling plates 320 (refer to FIG. 3) and the surface-pressure members 330 together between the battery cells 310. The battery cells 310, the cooling plates 320, and the surface-pressure members 330 stacked in the second direction may be a battery cell stack 300.

The plate stacking operation S20 may include stacking the end plates 340 on opposite sides of the battery cell stack 300 in the second direction, after the cell stacking operation S10.

The sensing assembly assembling operation S30 may be an operation of assembling a pair of sensing assemblies 400 on opposite sides of the battery cells 310 in the first direction, after the plate stacking operation S20.

The sensing assembly assembling operation S30 may include welding the leads of the battery cells 310 and the busbars of the sensing assemblies 400.

The mounting operation S40 may be an operation of mounting the battery cell stack 300, the end plates 340, and the sensing assemblies 400 into the module housing 200, after the sensing assembly assembling operation S30.

The gasket assembling operation S50 may be an operation of assembling the sealing gasket 600 outside the pair of sensing assemblies 400 in the first direction, after the mounting operation S40.

Here, the sealing gasket 600 disposed on one side of the battery cell stack 300 in the first direction, among the pair of sealing gaskets 600, may be assembled on one side of the sensing assembly 400 disposed on one side of the battery cell stack 300 in the first direction, and the sealing gasket 600 disposed on an opposite side of the battery cell stack 300 in the first direction, among the pair of sealing gaskets 600, may be assembled on an opposite side of the sensing assembly 400 in the first direction thereof.

The cover coupling operation S60 may be an operation of assembling the cover 500 for covering the sealing gasket 600 outside the sealing gasket 600 in the first direction, after the gasket assembling operation S50, to couple the cover 500 to the module housing 200.

Here, the cover 500 disposed on one side of the battery cell stack 300 in the first direction, among the pair of covers 500, may be assembled on one side of the sealing gasket 600 disposed on one side of the sensing assembly 400 in the first direction, and the cover 500 disposed on the opposite side of the battery cell stack 300 in the first direction, among the pair of covers 500, may be assembled on the opposite side of the sealing gasket 600 in the first direction of the sensing assembly 400.

Because the position of the sensing assembly 400 and the position of the sealing gasket 600 are guided by the structure and the manufacturing process of the battery module 100, productivity of the battery module 100 according to an exemplary embodiment of the present disclosure may be improved.

Furthermore, because the sealing gasket 600 seals the area between the cover 500 and the sensing assembly 400 in the first direction (the “X” direction or an opposite direction to the “X” direction) and the area between the sensing assembly 400 and the module housing 200 in the second direction (the “Y” direction or an opposite direction to the “Y” direction) or the third direction (the “Z” direction or an opposite direction to the “Z” direction), the flow of the cooling liquid in the interior of the battery module 100 may be guided, whereby the manufacturing process of the battery module 100 may be simplified and the productivity may be improved as a process of applying a separate adhesive for this maybe omitted.

According to the present technology, the cooling liquid that flows through the interior of the battery module may be prevented from leaking to the outside of the battery module because the sealing gasket seals the area between the cover and the sensing assembly.

Furthermore, according to the present technology, the flow of the cooling liquid in the interior of the battery module may be guided because the sealing gasket seals the area between the cover and the sensing assembly and the area between the sensing assembly and the module housing, so that a separate process of applying an adhesive for the present purpose may be omitted, simplifying the manufacturing process of the battery module and improving the productivity.

Furthermore, according to the present technology, because the position of the sensing assembly may be fixed by the sealing gasket, it may mitigate impacts applied to the sensing assembly from the outside of the battery module, and thus prevent an insulation breakdown between the busbars.

Furthermore, according to the present technology, the flow direction of the cooling liquid may be guided by the sealing gasket, the cooling performance of the battery module may be improved.

Furthermore, various effects which may be directly or indirectly identified through the present specification may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the exemplary embodiments included in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A battery module comprising:
battery cells of a battery cell stack extending in a first direction, and disposed in a second direction crossing the first direction;
a sensing assembly disposed on one side of the battery cell in the first direction;
a module housing covering the battery cells and the sensing assembly;
a cover coupled to the module housing and covering the sensing assembly; and
a sealing gasket disposed between the cover and the sensing assembly and fixing the sensing assembly.

2. The battery module of claim 1, wherein the sealing gasket extends along a circumferential direction of the cover.

3. The battery module of claim 1, wherein the sealing gasket contacts both of a circumferential area of the cover and a circumferential area of the sensing assembly, between the cover and the sensing assembly.

4. The battery module of claim 1, wherein the sealing gasket includes:
a peripheral portion contacting with the cover and extending along a circumferential direction of the cover; and
an extension portion extending from the peripheral portion toward the sensing assembly and contacting with the sensing assembly.

5. The battery module of claim 4, wherein the sensing assembly includes:
a sensing board, and a support frame supporting the sensing board, and
wherein the extension portion contacts with the support frame.

6. The battery module of claim 5, wherein the support frame includes:
a support portion supporting the sensing board; and
a protrusion portion protruding from a circumferential area of the support portion toward the cover, and extending along the circumferential direction of the support portion, and
wherein the extension portion contacts with the protrusion portion, inside of the protrusion portion.

7. The battery module of claim 4, wherein the peripheral portion is disposed between the cover and the module housing, and contacts with the cover and the module housing.

8. The battery module of claim 4,
wherein the peripheral portion and the extension portion of the sealing gasket define an opening hole in an interior of the sealing gasket.

9. The battery module of claim 1, wherein the sealing gasket extends in a circumferential direction of the cover and defines an opening hole in an interior of the sealing gasket.

10. The battery module of claim 9,
wherein the sensing assembly includes a busbar electrically connected to the battery cells, and
wherein the opening hole is formed on one side of the busbar in the first direction.

11. The battery module of claim 9, wherein the cover includes a cover hole fluidically communicating with the opening hole.

12. The battery module of claim 11, wherein the cover hole includes:
a first cover hole disposed on one side of the battery cell stack in the first direction; and
a second cover hole disposed on an opposite side of the battery cell stack in the first direction.

13. The battery module of claim 1, further comprising:
cooling plates disposed in the module housing; and
surface-pressure members disposed between the battery cells and contacting with the battery cells.

14. A method for manufacturing a battery module, the method comprising:
stacking battery cells extending in a first direction, in a second direction crossing the first direction;
assembling a sensing assembly on one side of the battery cells in the first direction;
mounting the battery cells and the sensing assembly in a module housing;
assembling a sealing gasket on one side of the sensing assembly in the first direction; and
coupling a cover for covering the sealing gasket to the module housing.
